(19) United States
(12) Patent Application Publication
(10) Pub. No.: US 2006/0040750 A1
(43) Pub. Date: Feb. 23, 2006

(54) Shaft coupling assembly

(76) Inventor: Hsi-Tsai Chen, Taichung City (TW)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 10/920,011

(22) Filed: Aug. 17, 2004

(51) Int. Cl. F16D 3/16

(52) U.S. Cl. 464/152

(57) ABSTRACT

A shaft coupling assembly includes a slide seat movable on a transmission member between a standby position and a coupling position, and a work shaft positioned within a shaft-receiving space in a curved flange of the transmission member by a positioning unit. The positioning unit includes a plurality of angularly equidistant first positioning holes formed in an outer surface of a coupling end of the work shaft, and a first positioning pin extending through the curved flange to engage a selected one of the first positioning holes.

### BACKGROUND OF THE INVENTION

1. Field of the Invention

This invention relates to a shaft coupling assembly, and more particularly to a shaft coupling assembly that includes a slide seat movable relative to a transmission member between a standby position and a coupling position.

2. Description of the Related Art

The applicant disclosed a shaft coupling assembly in U.S. Pat. No. 6,663,493, which can enhance the transmission efficiency and increase the service life. Although the shaft coupling assembly can achieve its intended purposes, in actual operation, it is difficult to position a work shaft stably relative to a transmission member.

### SUMMARY OF THE INVENTION

The object of this invention is to provide a shaft coupling assembly that includes a work shaft, which can be positioned stably relative to a transmission member. According to this invention, a shaft coupling assembly includes a bearing seat, and a driving unit including a driving shaft extending through the bearing seat along an axis and having an outer end that is disposed outwardly of the bearing seat. An annular transmission member is sleeved fixedly on the outer end of the driving shaft, and includes an annular portion having an outer end that is formed with a curved flange which extends axially away from the driving shaft and which is disposed around the axis. The curved flange defines a shaft-receiving space therein. An annular slide seat is sleeved movably on the transmission member, and is movable on the transmission member between a standby position, where the curved flange of the transmission member is disposed outwardly of the slide seat, and a coupling position, where the curved flange of the transmission member is disposed within the slide seat. A work shaft has a coupling end that is disposed within the shaft-receiving space in the transmission member and outwardly of the slide seat when the slide seat is disposed at the standby position and that is disposed within the shaft-receiving space in the transmission member and the slide seat when the slide seat is disposed at the coupling position. A connecting unit is spaced apart from the work shaft when the slide seat is disposed at the standby position, and couples the work shaft to the slide seat so as to enable synchronous rotation of the work shaft with the transmission member and the slide seat when the slide seat is disposed at the coupling position. A positioning unit includes a first positioning pin extending radially and inwardly from an inner surface of the curved flange of the transmission member, and a plurality of angularly equidistant first positioning holes formed in an outer surface of the end of said work shaft. The first positioning pin engages a selected one of the first positioning holes so as to position the work shaft within the shaft-receiving space in the transmission member.

### BRIEF DESCRIPTION OF THE DRAWINGS

These and other features and advantages of this invention will become apparent in the following detailed description of the preferred embodiments of this invention, with reference to the accompanying drawings, in which:

FIG. 1 is an exploded perspective view of the first preferred embodiment of a shaft coupling assembly according to this invention;

FIG. 2 is an exploded perspective view of a transmission member, a slide seat, and a connecting unit of the first preferred embodiment;

FIG. 3 is a side view of the first preferred embodiment, illustrating a standby position of the slide seat;

FIG. 4 is an assembled perspective view of the first preferred embodiment, illustrating the standby position of the slide seat;

FIG. 5 is a sectional view of the first preferred embodiment, illustrating the standby position of the slide seat;

FIG. 6 is a side view of the first preferred embodiment, illustrating a coupling position of the slide seat;

FIG. 7 is an assembled perspective view of the first preferred embodiment, illustrating the coupling position of the slide seat;

FIG. 8 is a sectional view of the first preferred embodiment, illustrating the coupling position of the slide seat;

FIG. 9 is a partly sectional view of the first preferred embodiment, illustrating the coupling position of the slide seat; and

FIG. 10 is an exploded perspective view of the second preferred embodiment of a shaft coupling assembly according to this invention.

### DETAILED DESCRIPTION OF THE PREFERRED EMBODIMENTS

Before the present invention is described in greater detail in connection with the preferred embodiments, it should be noted that similar elements and structures are designated by like reference numerals throughout the entire disclosure.

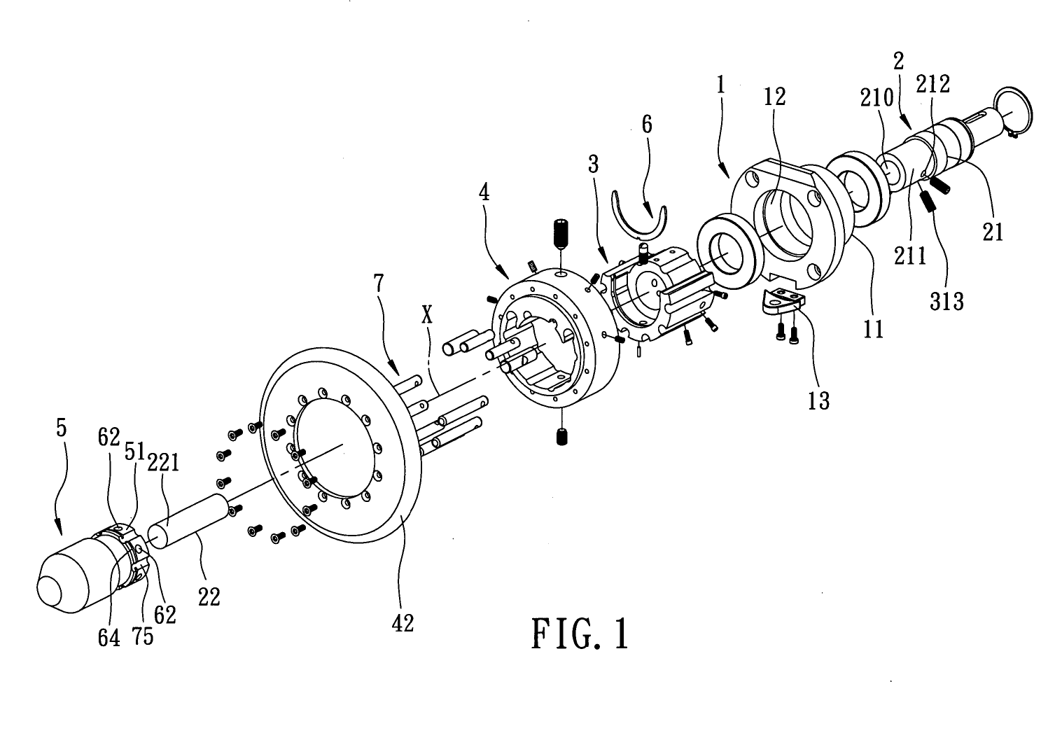

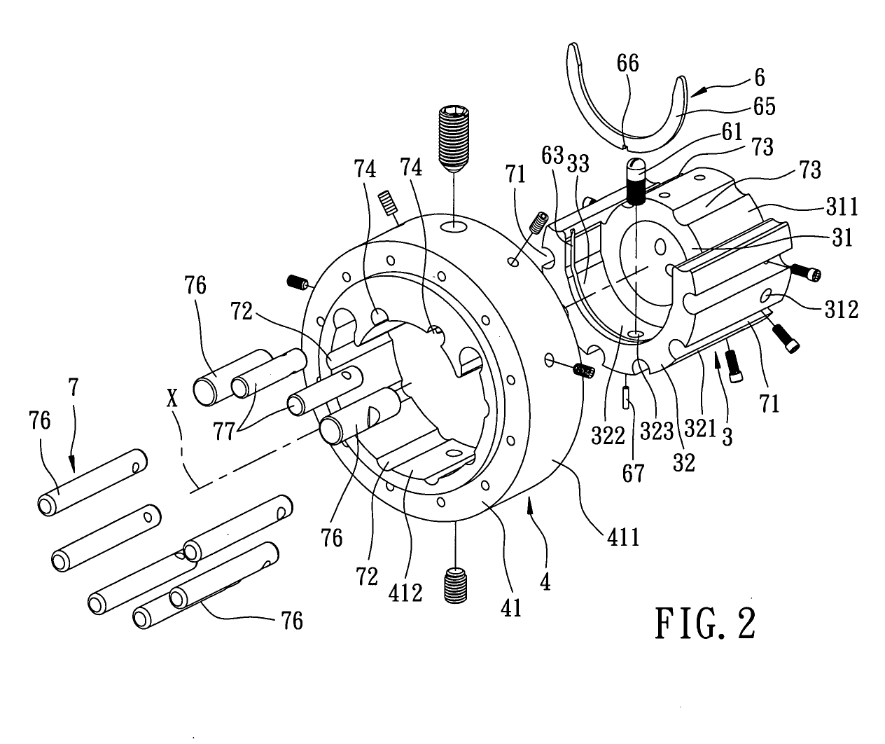

Referring to FIGS. 1 and 2, the first preferred embodiment of a shaft coupling assembly according to this invention is shown to include a bearing seat 1, a driving unit 2, an annular transmission member 3, an annular slide seat 4, a work shaft 5, a positioning unit 6, and a connecting unit 7.

The bearing seat 1 includes a seat body 11 that has a shaft hole 12 and a generally triangular projection 13. The shaft hole 12 is formed through the seat body 11, and extends along an axis (X). The projection 13 extends toward the slide seat 4.

The driving unit 2 includes a driving shaft 21 extending through the shaft hole 12 in the bearing seat 1, and a filling cylinder 22 press fitted within a cylindrical blind hole 210 that is formed in an outer end surface of the driving shaft 21. The driving shaft 21 has an outer end 211 disposed outwardly of the bearing seat 1, and a plurality of threaded holes 212 formed in an outer surface of the driving shaft 21, and is rotated by a power source (not shown). The driving shaft 21 may be a motor shaft.

The transmission member 3 is sleeved on the outer end of the driving shaft 21, and includes an annular portion 31 having an outer end that is formed with a curved flange 32, which extends axially away from the driving shaft 21, which is disposed around the axis (X), and which defines a shaft-receiving space 33 therein. The annular portion 31 has annular outer surface 311, a plurality of fastener holes 312, and a plurality of lock bolts 313 extending respectively through the fastener holes 312 and engaging respectively the threaded holes 212 in the driving shaft 21 so as to lock the transmission member 3 on the driving shaft 21. The curved flange 32 has an outer surface 321 and an inner surface 322.

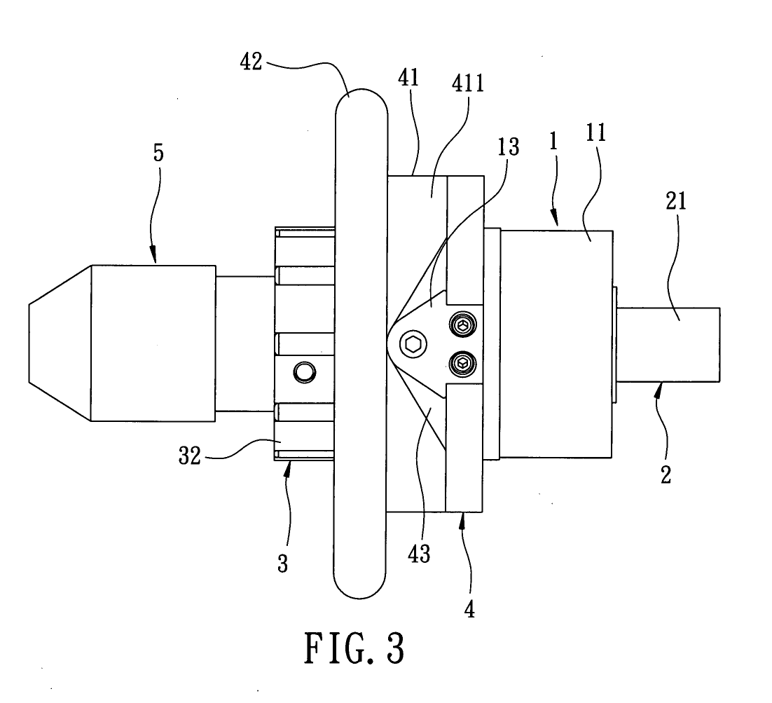

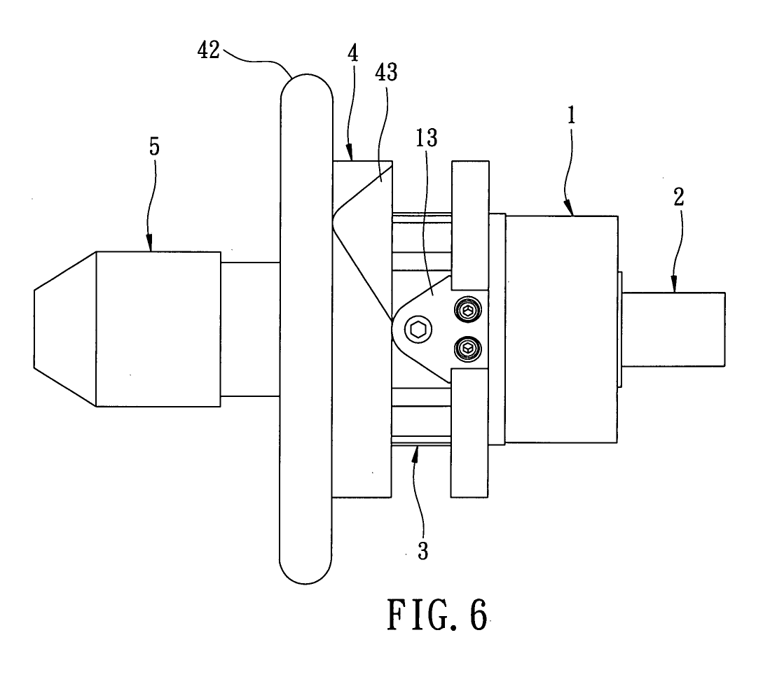

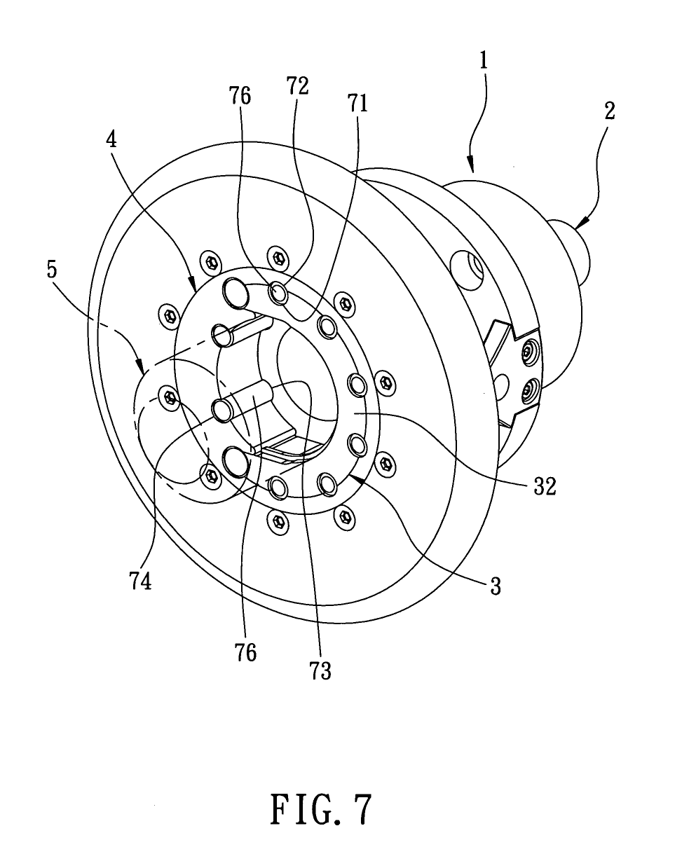

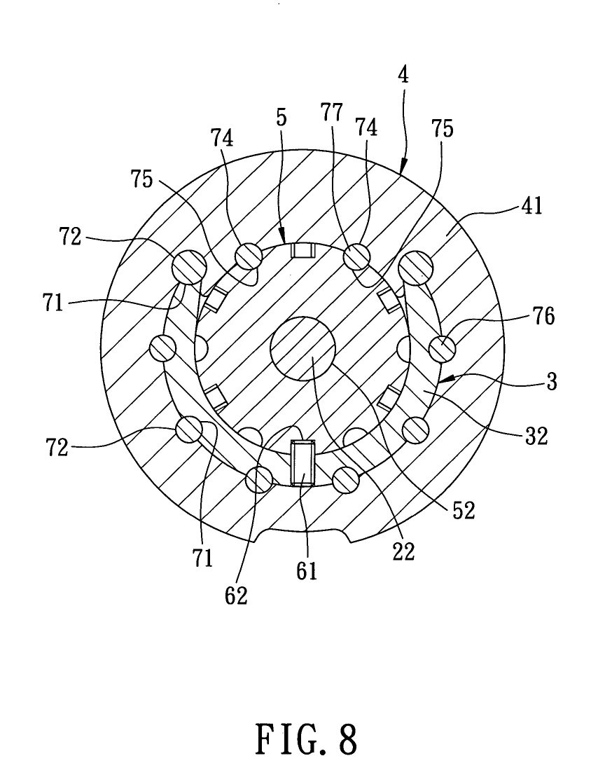

The slide seat 4 includes a surrounding wall 41 sleeved movably on the transmission member 3, and an outward flange 42. The surrounding wall 41 has an outer surface 411, an inner surface 412, a proximate end adjacent to the bearing seat 1, and a distal end distal from the bearing seat 1. The proximate end is formed with a generally V-shaped notch 43 (see FIG. 3). The outward flange 42 is fixed to and extends radially and outwardly from the distal end of the surrounding wall 41. The slide seat 4 is movable on the transmission member 3 between a standby position shown in FIGS. 3, 4, and 5, where the curved flange 32 of the transmission member 3 is disposed outwardly of the slide seat 4 and where the projection 13 of the bearing seat 1 is disposed within the notch 43 in the surrounding wall 41 of the slide seat 4, and a coupling position shown in FIGS. 6, 7, 8, and 9, where the curved flange 32 of the transmission member 3 is disposed within the slide seat 4 and where the projection 13 of the bearing seat 1 is removed from the notch 43 in the surrounding wall 41 of the slide seat 4. The transmission member 3 and the slide seat 4 are formed from a single piece by cutting so as to maintain concentricity thereof during assembly.

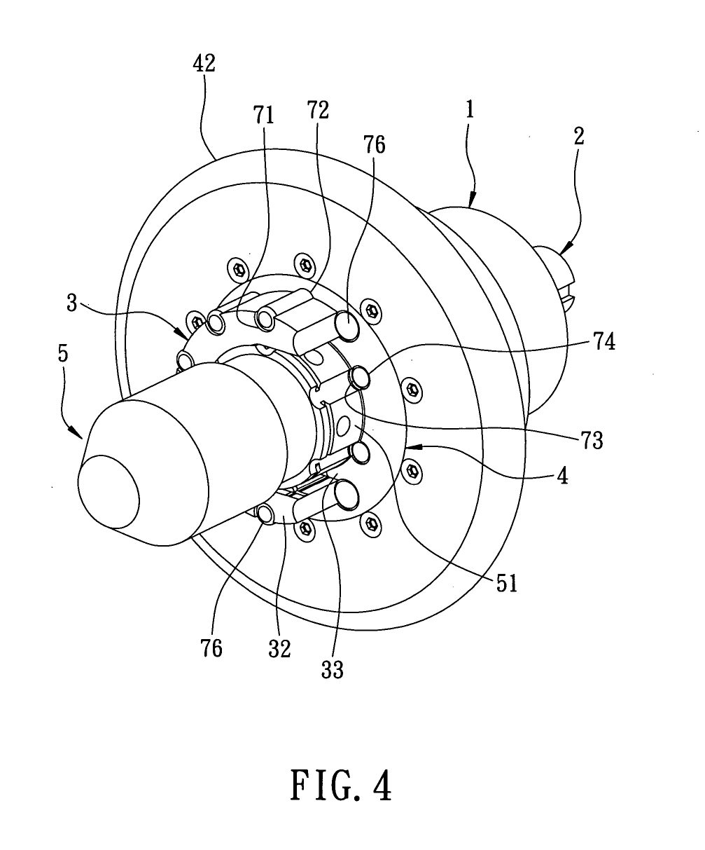

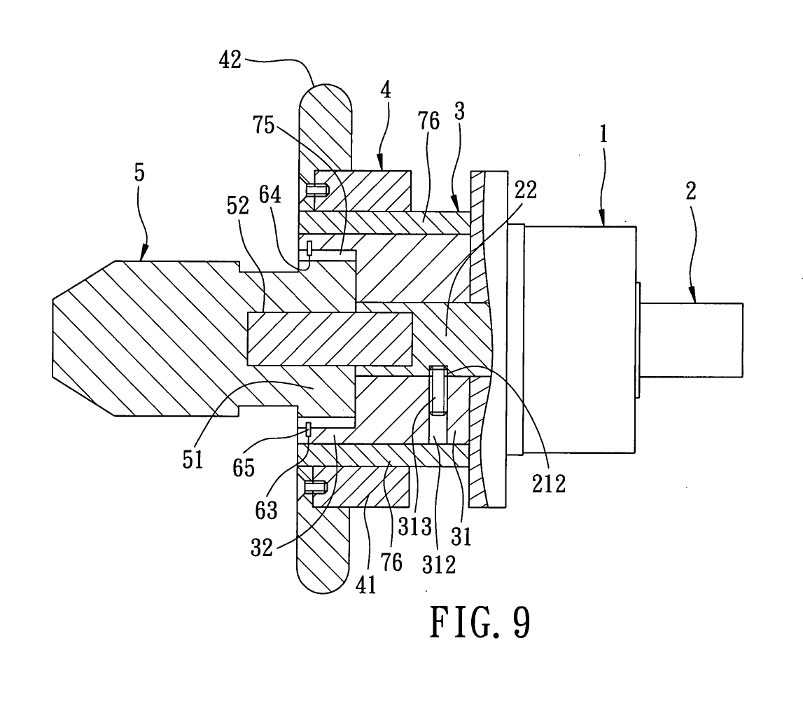

The work shaft 5 has a coupling end 51 that has an end surface, which is formed with a cylindrical blind hole 52 (see FIG. 9). The blind hole 52 extends along the axis (X). When the slide seat 4 is disposed at the standby position, the coupling end 51 of the work shaft 5 is disposed within the shaft-receiving space 33 in the transmission member 3 and outwardly of the slide seat 4, as shown in FIG. 4. When the slide seat 4 is disposed at the coupling position, the coupling end 51 of the work shaft 5 is disposed within the shaft-receiving space 33 (see FIG. 2) in the transmission member 3 and the slide seat 4, as shown in 9.

The positioning unit 6 includes a first positioning pin 61, a plurality of angularly equidistant first positioning holes 62, a curved slot 63, an annular slot 64, a C-shaped retaining ring 65, a second positioning hole 66, and a second positioning pin 67. The first positioning pin 61 extends radially and inwardly from the inner surface 322 of the curved flange 32 of the transmission member 3. The first positioning holes 62 are formed in the outer surface of the end 51 of the work shaft 5. The first positioning pin 61 engages a selected one of the first positioning holes 62 so as to position the work shaft 5 within the shaft-receiving space 33 in the transmission member 3. The curved flange 32 of the transmission member 3 is formed with a threaded hole 323 therethrough. The positioning pin 61 is configured as a bolt that engages the threaded hole 323 in the curved flange 32 of the transmission member 3. The curved slot 63 is formed in the inner surface 322 of the curved flange 32 of the transmission member 3, and has two open ends. The annular slot 64 is formed in the outer surface of the end 51 of the work shaft 5. The C-shaped retaining ring 65 is received within the curved slot 63 and the annular slot 64 so as to prevent axial movement of the work shaft 5 within the shaft-receiving space 33 in the transmission member 3. The second positioning hole 66 is formed in the C-shaped retaining ring 65. The second positioning pin 67 extends through the curved flange 32 of the transmission member 3 to engage the second positioning hole 66 in the C-shaped retaining ring 65 so as to prevent movement of the C-shaped retaining ring 65 within the curved slot 63 in the curved flange 32 of the transmission member 3 and the annular slot 64 in the end 51 of the work shaft 5.

The connecting unit 7 is spaced apart from the work shaft 5 when the slide seat 4 is disposed at the standby position, and couples the work shaft 5 to the slide seat 4 so as to enable synchronous rotation of the work shaft 5 with the transmission member 3 and the slide seat 4 when the slide seat 4 is disposed at the coupling position.

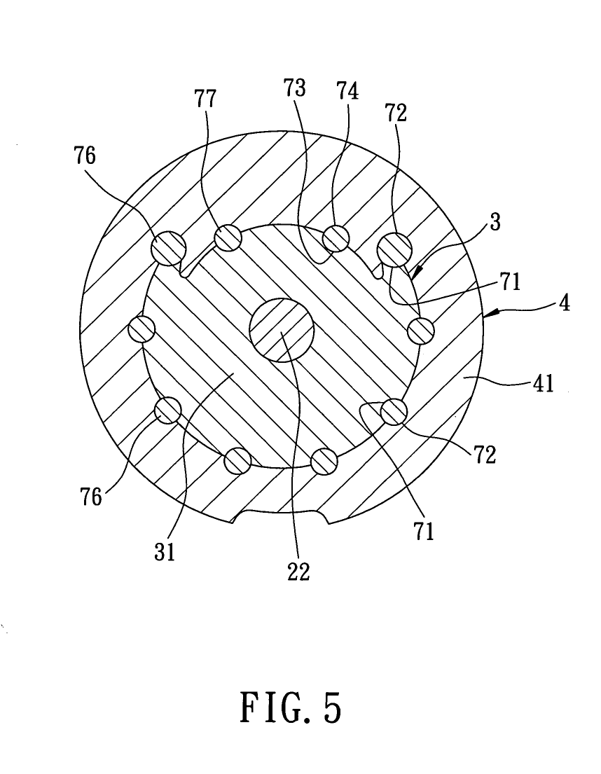

The connecting unit 7 includes eight axially extending first slots 71, eight axially extending second slots 72, two axially extending third slots 73, two axially extending fourth slots 74, two axially extending fifth slots 75, eight first transmission cylinders 76, and two second transmission cylinders 77. Each of the first slots 71 is formed in outer surfaces of the annular body 31 and the curved flange 32 of the transmission member 3, and has two open ends. The second slots 72 are formed in the inner surface 412 of the slide seat 4. The third slots 73 are formed in the outer surface 311 of the annular body 31 of the transmission member 3. The fourth slots 74 are formed in the inner surface 412 of the slide seat 4. The fifth slots 75 are formed in the outer surface of the end 51 of the work shaft 5 in an angularly equidistant manner. Each of the first transmission cylinders 76 is connected threadedly to one of the transmission member 3 and the slide seat 4, and engages a respective one of the first slots 71 in the transmission member 3 and a respective one of the second slots 72 in the slide seat 4. The second transmission cylinders 77 engage respectively the fourth slots 74 in the slide seat 4, and are connected threadedly to the slide seat 4. When the slide seat 4 is disposed at the standby position, each of the second transmission cylinders 77 engages a respective one of the third slots 73 in the transmission member 3, and is spaced apart from a corresponding one of the fifth slots 75 in the end 51 of the work shaft 5, as shown in FIG. 5. When the slide seat 4 is disposed at the coupling position, each of the second transmission cylinders 77 engages the respective one of the third slots 73 in the transmission member 3 and the corresponding one of the fifth slots 75 in the end 51 of the work shaft 5 so as to enable synchronous rotation of the work shaft 5 with the transmission member 3 and the slide seat 4.

In operation, the projection 13 of the bearing seat 1 is placed into the notch 43 in the surrounding wall 41 of the slide seat 4 so as to dispose the slide seat 4 at the standby position shown in FIGS. 3, 4, and 5. The end 51 of the work shaft 5 is placed into the shaft-receiving space 33 in the transmission member 3. The first positioning pin 61 is passed through the threaded hole 323 in the curved flange 32 of the transmission member 3 to engage the selected one of the first positioning holes 62 in the end 51 of the work shaft 5. The C-shaped retaining ring 65 is placed between the curved flange 32 of the transmission member 3 and the work shaft 5 so as to engage the curved slot 63 in the curved flange 32 and the annular slot 64 in the work shaft 5. The second positioning pin 67 is passed through the curved flange 32 of the transmission member 3 to engage the second positioning hole 66 in the C-shaped retaining ring 65.

Subsequently, the outward flange 42 of the slide seat 4 is rotated relative to the bearing seat 1. Hence, a wall of the surrounding wall 41 of the slide seat 4 defining the notch 43 moves on the projection 13 of the bearing seat 1 so as to move the slide seat 4 relative to the transmission member 3 along the axis (X) until the slide seat 4 reaches the coupling position shown in FIGS. 6, 7, 8, and 9. As a consequence, the end surface of the end 51 of the work shaft 5 contacts the outer end surface of the driving shaft 21 such that the filling cylinder 22 engages fittingly the blind hole 52 in the work shaft 5. Therefore, the work shaft 5 can be positioned stably relative to the driving shaft 21. The bearing seat 1, the driving unit 2, the transmission member 3, the slide seat 4, the positioning unit 6, and the connecting unit 7 constitute cooperatively a work shaft-driving device.

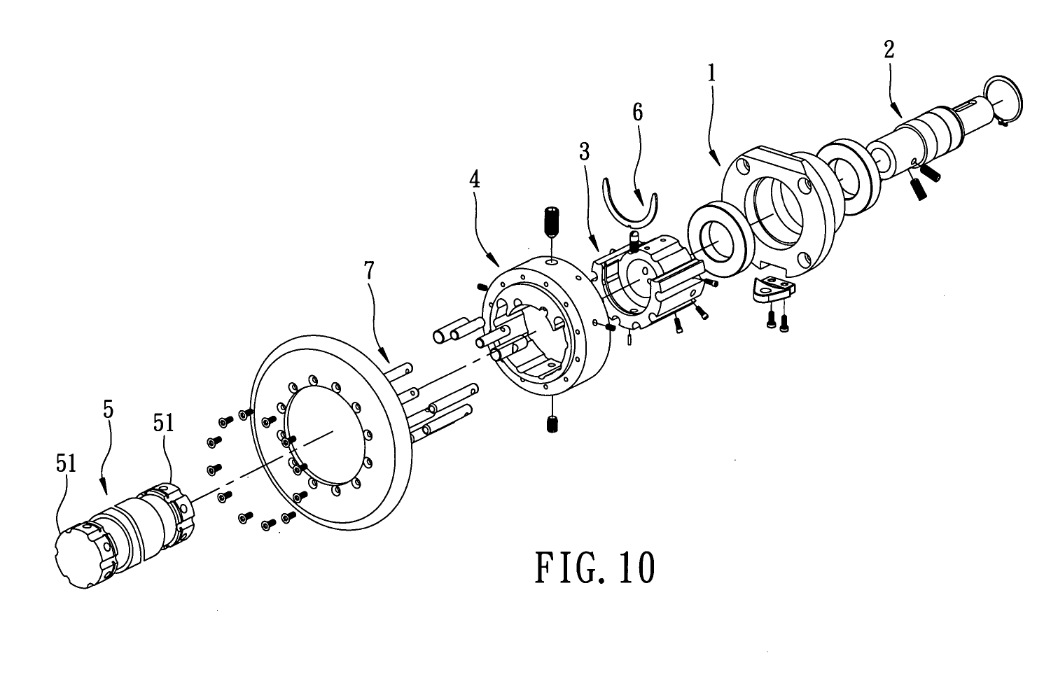

FIG. 10 shows the second preferred embodiment of a shaft coupling assembly according to this invention. Unlike the previous embodiment, the work shaft 5 has two coupling ends 51 that are coupled respectively to two work shaft-driving devices (only one is shown). The filling cylinder 22 and the blind holes 52, 210 in the work shaft 5 and the driving shaft 21 are excluded.

The shaft coupling assembly of this invention has the following advantages:
(1) The work shaft 5 can be positioned stably relative to the transmission member 3 by the positioning unit 6.
(2) The transmission member 3 and the slide seat 4 are formed from the single piece by cutting so as to maintain the concentricity thereof, thereby allowing for smooth and stable rotation of the work shaft 5. This causes increased service life of the shaft coupling assembly.

With this invention thus explained, it is apparent that numerous modifications and variations can be made without departing from the scope and spirit of this invention. It is therefore intended that this invention be limited only as indicated by the appended claims.

I claim:

1. A shaft coupling assembly comprising:
a bearing seat;
a driving unit including a driving shaft extending through said bearing seat along an axis and having an outer end that is disposed outwardly of said bearing seat;
an annular transmission member sleeved fixedly on said outer end of said driving shaft and including an annular portion having an outer end that is formed with a curved flange which extends axially away from said driving shaft and which is disposed around said axis, said curved flange defining a shaft-receiving space therein;
an annular slide seat sleeved movably on said transmission member and movable on said transmission member between a standby position, where said curved flange of said transmission member is disposed outwardly of said slide seat, and a coupling position, where said curved flange of said transmission member is disposed within said slide seat;
a work shaft having a coupling end that is disposed within said shaft-receiving space in said transmission member and outwardly of said slide seat when said slide seat is disposed at said standby position and that is disposed within said shaft-receiving space in said transmission member and said slide seat when said slide seat is disposed at said coupling position;
a connecting unit spaced apart from said work shaft when said slide seat is disposed at said standby position and coupling said work shaft to said slide seat so as to enable synchronous rotation of said work shaft with said transmission member and said slide seat when said slide seat is disposed at said coupling position; and
a positioning unit that includes:
a first positioning pin extending radially and inwardly from an inner surface of said curved flange of the transmission member, and
a plurality of angularly equidistant first positioning holes formed in an outer surface of said end of said work shaft, said first positioning pin engaging a selected one of said first positioning holes so as to position said work shaft within said shaft-receiving space in said transmission member.

2. The shaft coupling assembly as claimed in claim 1, wherein said curved flange of said transmission member is formed with a threaded hole therethrough, said first positioning pin being configured as a bolt that engages said threaded hole in said curved flange.

3. The shaft coupling assembly as claimed in claim 1, wherein said positioning unit further includes:
a curved slot formed in the inner surface of said curved flange of said transmission member and having two open ends;
an annular slot formed in the outer surface of said end of said work shaft; and
a C-shaped retaining ring received within said curved slot in said curved flange of said transmission member and said annular slot in said work shaft so as to prevent axial movement of said work shaft within said shaft-receiving space in said transmission member.

4. The shaft coupling assembly as claimed in claim 3, wherein said positioning unit further includes:
a second positioning hole formed in said C-shaped retaining ring; and
a second positioning pin extending through said curved flange of said transmission member and engaging said second positioning hole in said C-shaped retaining ring so as to prevent movement of said C-shaped retaining ring within said curved slot in said curved flange of said transmission member and said annular slot in said end of said work shaft.

5. The shaft coupling assembly as claimed in claim 1, wherein said connecting unit includes:
a plurality of axially extending first slots formed in outer surfaces of said annular body and said curved flange of said transmission member;
a plurality of axially extending second slots formed in an inner surface of said slide seat;
a plurality of first transmission cylinders, each of which is connected fixedly to one of said transmission member and said slide seat and engaging a respective one of said first slots in said transmission member and a respective one of said second slots in said slide seat so as to enable synchronous rotation of said transmission member and said slide seat;
two axially extending third slots formed in said outer surface of said annular portion of said transmission member;
two axially extending fourth slots formed in said inner surface of said slide seat;
a plurality of axially extending fifth slots formed in said end of said work shaft in an angularly equidistant manner; and
two second transmission cylinders fixed respectively within said fourth slots in said slide seat, each of said second transmission cylinders engaging a respective one of said third slots in said transmission member and being spaced apart from a corresponding one of said fifth slots in said end of said work shaft when said slide seat is disposed at said standby position and engaging the respective one of said third slots in said transmission member and the corresponding one of said fifth slots in said end of said work shaft so as to enable synchronous rotation of said work shaft with said transmission member and said slide seat when said slide seat is disposed at said coupling position.

6. The shaft coupling assembly as claimed in claim 1, wherein each of said outer end of said driving shaft and said coupling end of said work shaft has an end surface that is formed with a cylindrical blind hole which extends along said axis, said driving unit further including a filling cylinder that is press fitted within said blind hole in said driving shaft and that engages fittingly said blind hole in said work shaft so as to position said work shaft relative to said driving shaft when said slide seat is disposed at said coupling position.

7. The shaft coupling assembly as claimed in claim 1, wherein said slide seat includes:
a surrounding wall having a proximate end adjacent to said bearing seat, and a distal end distal from said bearing seat, said proximate end being formed with a generally V-shaped notch; and
an outward flange extending radially and outwardly from said surrounding wall;
said bearing seat being formed with a generally triangular projection extending into said V-shaped notch in said surrounding wall of said slide seat when said slide seat is disposed at said standby position, a wall of said surrounding wall of said slide seat defining said V-shaped notch being movable on said projection in response to rotation of said outward flange relative to said bearing seat so as to move said slide seat relative to said transmission member along said axis until said slide seat reaches said coupling position.

8. The shaft coupling assembly as claimed in claim 1, wherein said driving shaft has an outer surface that is formed with a plurality of radially extending threaded holes, said annular portion of said transmission member being formed with a plurality of fastener holes therethrough, said transmission member further including a plurality of bolts that extend respectively through said fastener holes in said annular portion of said transmission member and that engage respectively said threaded holes in said driving shaft so as to lock said transmission member on said driving shaft.
